(19) United States
(12) Patent Application Publication
(10) Pub. No.: US 2025/0305161 A1
(43) Pub. Date: Oct. 2, 2025

(54) DIFFERENTIAL PRESSURE ELECTROLYSIS CELL, DIFFERENTIAL PRESSURE ELECTROLYSIS STACK, AND METHOD OF PRODUCING DIFFERENTIAL PRESSURE ELECTROLYSIS CELL

(71) Applicant: HONDA MOTOR CO., LTD., TOKYO (JP)

(72) Inventors: Yohei KATAOKA, WAKO-SHI (JP); Shinsuke CHOKYU, WAKO-SHI (JP); Kento KUSATSUGU, WAKO-SHI (JP); Wataru KASHI, WAKO-SHI (JP)

(21) Appl. No.: 19/064,938

(22) Filed: Feb. 27, 2025

(30) Foreign Application Priority Data
Mar. 26, 2024 (JP) 2024-049889

(51) Int. Cl. C25B 9/23; C25B 9/05; C25B 9/77; C25B 13/02

(52) U.S. Cl. CPC C25B 9/23; C25B 9/05; C25B 9/77; C25B 13/02

(57) ABSTRACT

A differential pressure electrolysis cell for producing a gas having a higher pressure than a fluid at the second electrode by applying a voltage between a first electrode and a second electrode to electrolyze the fluid containing water and supplied to the first electrode, wherein an electrolyte membrane of the differential pressure electrolysis cell includes: a first layer facing the first electrode and having a first ion exchange capacity per unit area; and a second layer facing the second electrode and having a second ion exchange capacity per unit area, and the second ion exchange capacity is larger than the first ion exchange capacity.

### CROSS-REFERENCE TO RELATED APPLICATIONS

This application is based upon and claims the benefit of priority from Japanese Patent Application No. 2024-049889 filed on Mar. 26, 2024, the contents of which are incorporated herein by reference.

### BACKGROUND OF THE INVENTION

### Field of the Invention

The present disclosure relates to a differential pressure electrolysis cell, a differential pressure electrolysis stack, and a method of producing the differential pressure electrolysis cell.

### Description of the Related Art

In recent years, research and development have been conducted on differential pressure electrolysis stacks that contribute to energy efficiency in order to ensure that more people have access to affordable, reliable, sustainable and modern energy.

For example, JP 7031719 B2 discloses a differential pressure water electrolysis stack including a polymer electrolyte membrane having an excellent hydrogen barrier property.

### SUMMARY OF THE INVENTION

To provide a better differential pressure electrolysis cell, a differential pressure electrolysis stack, and a method of producing the differential pressure electrolysis cell.

The present disclosure has the object of solving the aforementioned problem.

A first aspect of the present disclosure is to provide a differential pressure electrolysis cell including a membrane electrode assembly including an electrolyte membrane sandwiched between a first electrode and a second electrode, the differential pressure electrolysis cell being configured to cause a gas to be produced at the second electrode by applying a voltage between the first electrode and the second electrode for electrolyzing a fluid that contains water and is supplied to the first electrode, a pressure of the gas being higher than a pressure of the fluid, wherein the electrolyte membrane includes: a first layer facing the first electrode and having a first ion exchange capacity per unit area; and a second layer facing the second electrode and having a second ion exchange capacity per unit area, and the second ion exchange capacity is larger than the first ion exchange capacity.

A second aspect of the present disclosure is to provide a differential pressure electrolysis stack including a cell stack body in which a plurality of differential pressure electrolysis cells according to the first aspect are stacked.

A third aspect of the present disclosure is to provide a method of producing a differential pressure electrolysis cell including a membrane electrode assembly including an electrolyte membrane sandwiched between a first electrode and a second electrode, the differential pressure electrolysis cell being configured to cause a gas to be produced at the second electrode by applying a voltage between the first electrode and the second electrode for electrolyzing a fluid that contains water and is supplied to the first electrode, a pressure of the gas being higher than a pressure of the fluid, the method including: an electrolyte membrane forming step of forming an electrolyte membrane including a first layer having a first ion exchange capacity per unit area and a second layer having a second ion exchange capacity per unit area; and a placing step of placing the electrolyte membrane between the first electrode and the second electrode in such a manner that the first layer faces the first electrode and the second layer faces the second electrode.

According to the present disclosure, a better differential pressure electrolysis cell, a better differential pressure electrolysis stack, and a better method of producing a differential pressure electrolysis cell can be provided.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic view of an electrolysis apparatus including a differential pressure electrolysis stack according to an embodiment;

FIG. 2 is a cross-sectional view of a differential pressure electrolysis cell;

FIG. 3 is a cross-sectional view illustrating an electrolyte membrane;

FIG. 4 is a flowchart illustrating an example of a method of producing a differential pressure electrolysis cell;

FIGS. 5A, 5B and 5C are cross-sectional explanatory views showing an example of the method of producing the differential pressure electrolysis cell;

FIG. 6 is a flowchart showing an example of an electrolyte membrane forming step; and

FIG. 7A and FIG. 7B are cross-sectional views illustrating an example of the step of forming the electrolyte membrane.

### DETAILED DESCRIPTION OF THE INVENTION

A differential pressure electrolysis cell includes a membrane electrode assembly. The membrane electrode assembly is formed by sandwiching an electrolyte membrane between a first electrode and a second electrode. The differential pressure electrolysis cell is configured to cause a gas to be produced at the second electrode by applying a voltage between the first electrode and the second electrode for electrolyzing a fluid containing water and supplied to the first electrode, a pressure of the gas being higher than a pressure of the fluid. In such a differential pressure electrolysis cell, the electrolyte membrane is humidified by the fluid containing water and supplied to the first electrode.

Specifically, the water supplied to the first electrode moves through the electrolyte membrane from the first electrode toward the second electrode. However, because the water moving through the electrolyte membrane from the first electrode toward the second electrode is pushed back to the first electrode by the pressure of the high pressure gas produced at the second electrode, the portion of the electrolyte membrane facing the second electrode is more likely to be dried out than the portion of the electrolyte membrane facing the first electrode. In other words, the electrolyte membrane is likely to vary in water content in the thickness direction. If the electrolyte membrane is dried out, the movement of ions in the electrolyte membrane is inhibited, tending to decrease the efficiency of electrolysis or accelerate deterioration of the electrolyte membrane due to an increase in electrical resistance. The present disclosure can provide a differential pressure electrolysis cell, a differential pressure electrolysis stack, and a method of producing the differential pressure electrolysis cell, which can suppress a decrease in electrolysis efficiency and progress of deterioration of the electrolyte membrane by suppressing the electrolyte membrane from being dried out in a portion facing the second electrode.

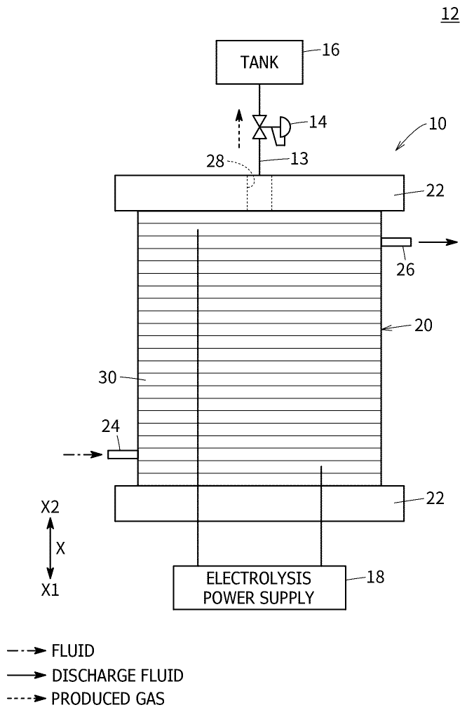

FIG. 1 is a schematic view of an electrolysis apparatus 12 including a differential pressure electrolysis stack 10 according to an embodiment. As shown in FIG. 1, the electrolysis apparatus 12 includes, for example, the differential pressure electrolysis stack 10, a gas discharge path 13, a back pressure valve 14, a tank 16, and an electrolytic power supply 18.

The differential pressure electrolysis stack 10 is capable of producing a high pressure gas by electrolyzing a fluid. The differential pressure electrolysis stack 10 includes a cell stack body 20, a pair of end plates 22, an inlet 24, an outlet 26, and a produced gas discharge opening 28.

The cell stack body 20 is formed by stacking a plurality of differential pressure electrolysis cells 30 in the X direction. The plurality of differential pressure electrolysis cells 30 are stacked in the vertical direction, for example. The plurality of differential pressure electrolysis cells 30 may be stacked in a direction intersecting the vertical direction (for example, a horizontal direction). The pair of end plates 22 sandwich the plurality of differential pressure electrolysis cells 30 in the X direction. A fluid is supplied to the inside of the cell stack body 20 through the inlet 24. The fluid is discharged to the outside of the cell stack body 20 through the outlet 26. The gas produced inside the cell stack body 20 is guided to the gas discharge path 13 through the produced gas discharge opening 28. The produced gas discharge opening 28 is provided, for example, in the central portion of the end plate 22.

The gas discharge path 13 guides the produced gas produced in the cell stack body 20 to the tank 16. The gas discharge path 13 is provided with the back pressure valve 14. The back pressure valve 14 opens in a case where the pressure of the gas guided from the differential pressure electrolysis stack 10 is equal to or higher than a predetermined threshold. The back pressure valve 14 closes in a case where the pressure of the produced gas guided from the differential pressure electrolysis stack 10 is less than the threshold. The tank 16 is a high pressure gas tank that can store the gas produced by the differential pressure electrolysis stack 10.

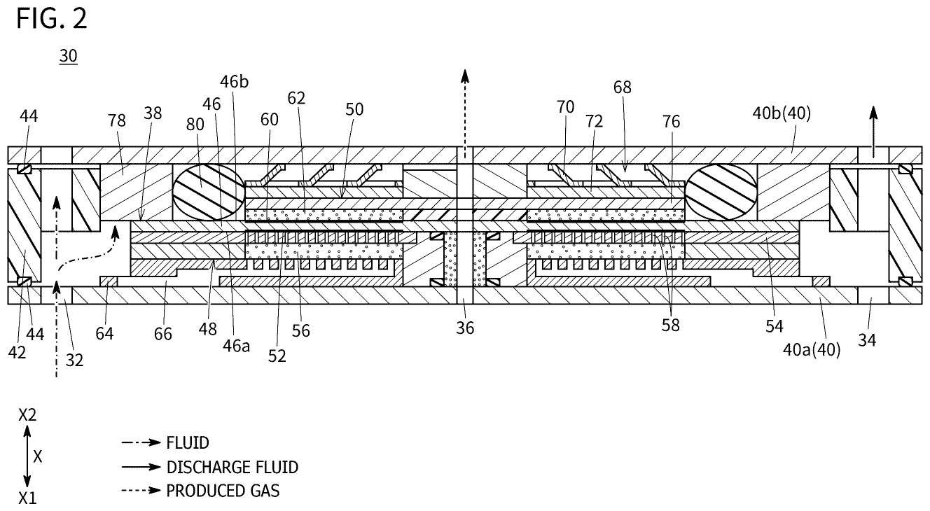

FIG. 2 is a cross-sectional view of the differential pressure electrolysis cell 30. As shown in FIG. 2, the differential pressure electrolysis cell 30 is provided with a fluid supply passage 32, a fluid discharge passage 34, and a produced gas discharge passage 36 that extend through the differential pressure electrolysis cell 30 in the X direction. The fluid supply passage 32 extends through the plurality of differential pressure electrolysis cells 30. The fluid supply passage 32 is in communication with the inlet 24 (see FIG. 1). The fluid discharge passage 34 extends through the plurality of differential pressure electrolysis cells 30. The fluid discharge passage 34 is in communication with the outlet 26 (see FIG. 1). The produced gas discharge passage 36 extends through the plurality of differential pressure electrolysis cells 30. The produced gas discharge passage 36 is in communication with the produced gas discharge opening 28 (see FIG. 1).

The fluid supply passage 32 and the fluid discharge passage 34 are provided in the outer peripheral portion of the differential pressure electrolysis cell 30 at positions separate from each other. The produced gas discharge passage 36 is provided in the central portion of the differential pressure electrolysis cell 30. The produced gas discharge passage 36 is positioned between the fluid supply passage 32 and the fluid discharge passage 34. The fluid is supplied to the first electrode 48 through the fluid supply passage 32. The fluid (discharge fluid) that has passed through the first electrode 48 is guided to the fluid discharge passage 34. The gas produced at the second electrode 50 is guided to the produced gas discharge passage 36.

The differential pressure electrolysis cell 30 includes a membrane electrode assembly 38, a pair of separators 40, and a frame member 42. The pair of separators 40 sandwich the membrane electrode assembly 38. The frame member 42 is formed in an annular shape so as to surround the membrane electrode assembly 38. A seal member 44 is provided between the frame member 42 and each of the separators 40 for preventing the fluid and the discharge fluid from flowing to the outside. Hereinafter, in FIG. 2, one of the pair of separators 40 on the X1 side of the membrane electrode assembly 38 may be referred to as a “first separator 40a”, and the other of the pair of separators 40 on the X2 side of the membrane electrode assembly 38 may be referred to as a “second separator 40b”.

The membrane electrode assembly 38 is formed in an annular shape (for example, a circular ring shape). The membrane electrode assembly 38 includes an electrolyte membrane 46, a first electrode 48, and a second electrode 50. The electrolyte membrane 46 is sandwiched between the first electrode 48 and the second electrode 50. The electrolyte membrane 46 is an ion exchange membrane. Specifically, the electrolyte membrane 46 is, for example, a proton exchange membrane (PEM). The electrolyte membrane 46 may be an anion exchange membrane (AEM). The electrolyte membrane 46 prevents the gas produced at the second electrode 50 (produced gas) from passing through the electrolyte membrane toward the first electrode 48. A specific configuration of the electrolyte membrane 46 will be described later.

The first electrode 48 includes a first catalyst layer 52, a protective sheet 54, and a first current collector 56. The first catalyst layer 52 is joined to one surface 46a (surface facing the X1 direction) of the electrolytic membrane 46. The first current collector 56 also serves as a fluid diffusion layer for supplying the fluid to the first catalyst layer 52. The first current collector 56 includes a portion formed of a porous member. The protective sheet 54 is disposed between the first catalyst layer 52 and the first current collector 56. The protective sheet 54 prevents the electrolyte membrane 46 from being damaged by the first current collector 56 pressing the electrolyte membrane 46 due to the gas produced at the second electrode 50. A plurality of through holes 58 are formed in the protective sheet 54.

The outer diameter of the second electrode 50 is smaller than the outer diameter of the first electrode 48. The second electrode 50 includes a second catalyst layer 60 and a second current collector 62. The second catalyst layer 60 is joined to the other surface 46b (surface facing the X2 direction) of the electrolytic membrane 46. The second current collector 62 also serves as a gas diffusion layer for leading out the gas produced at the second catalyst layer 60. The second current collector 62 includes a portion formed of a porous member.

A support member 64 that supports the membrane electrode assembly 38 is provided between the first separator 40a and the first current collector 56. A communication path 66 is formed in the support member 64. The communication path 66 guides the fluid introduced from the fluid supply passage 32 into the first current collector 56. The communication path 66 guides the discharge fluid in the first current collector 56 to the fluid discharge passage 34.

A load applying mechanism 68 that biases the second current collector 62 in the X1 direction is provided between the second current collector 62 and the second separator 40b. The load applying mechanism 68 includes, for example, a plate spring 70, a plate spring holder 72, and a conductive sheet 76. An annular member 78 is provided between the second separator 40b and the outer peripheral portion of the electrolytic membrane 46. The annular member 78 is made of pressure resistant copper. The annular member 78 is in liquid-tight and air-tight contact with the other surface 46b of the electrolytic membrane 46. An annular seal member 80 is disposed between the annular member 78 and the load applying mechanism 68. The seal member 80 is in contact with each of the second separator 40b and the electrolytic membrane 46.

As shown in FIG. 1, the electrolytic power supply 18 is a direct current power supply. The electrolytic power supply 18 applies a voltage between the first current collector 56 and the second current collector 62 shown in FIG. 2.

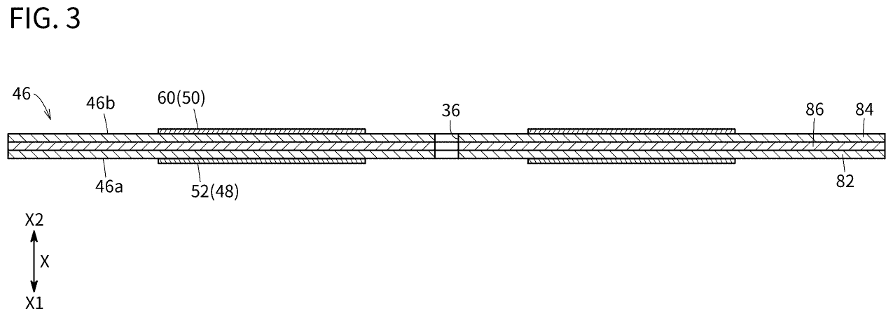

FIG. 3 is a cross-sectional view illustrating the electrolyte membrane 46. As shown in FIG. 3, the electrolyte membrane 46 has a laminate structure formed by laminating three layers, for example. Specifically, the electrolyte membrane 46 includes a first layer 82, a second layer 84, and an intermediate layer 86. The first layer 82 faces the first electrode 48. The second layer 84 faces the second electrode 50. The intermediate layer 86 is interposed between the first layer 82 and the second layer 84.

The first layer 82 is made of a first ionomer material having a first ion exchange capacity per unit area. The second layer 84 is made of a second ionomer material having a second ion exchange capacity per unit area. The intermediate layer 86 is made of a third ionomer material having a third ion exchange capacity per unit area.

The second ion exchange capacity is larger than the first ion exchange capacity. That is, the maximum water content per unit area of the second layer 84 is greater than the maximum water content per unit area of the first layer 82. The third ion exchange capacity is larger than the first ion exchange capacity and smaller than the second ion exchange capacity. That is, the maximum water content per unit area of the intermediate layer 86 is larger than the maximum water content per unit area of the first layer 82 and smaller than the maximum water content per unit area of the second layer 84.

The first layer 82, the second layer 84, and the intermediate layer 86 have the same thickness. The thicknesses of the first layer 82, the second layer 84, and the intermediate layer 86 may be different from each other. In the present embodiment, the intermediate layer 86 may be omitted. If this is the case, the electrolyte membrane 46 is formed of only two layers (the first layer 82 and the second layer 84). The electrolyte membrane 46 may be formed by laminating four or more layers, for example. In other words, the electrolyte membrane 46 may include a plurality of intermediate layers 86. If this is the case, the ion exchange capacity per unit area of the plurality of intermediate layers 86 may be the same as each other or may be different from each other. In the case where the ion exchange capacities of the plurality of intermediate layers 86 per unit area are different from each other, the plurality of intermediate layers 86 are preferably arranged such that the ion exchange capacities per unit area increase toward the X1 direction.

The electrolysis apparatus 12 may include components other than the above-described components.

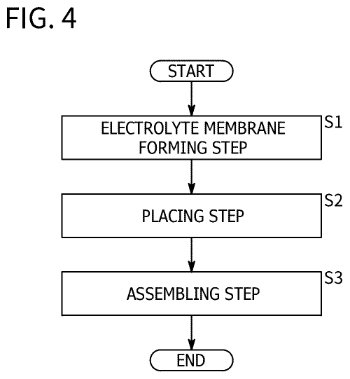

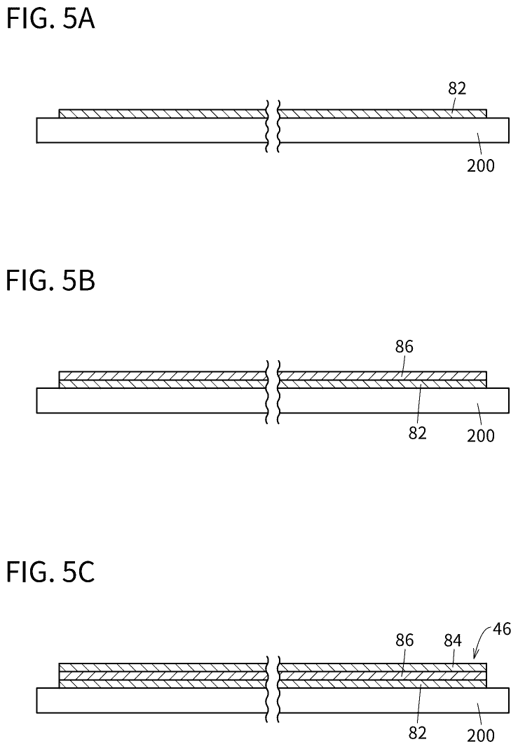

Next, a method of producing the differential pressure electrolysis cell 30 will be described. FIG. 4 is a flowchart illustrating an example of a method of producing the differential pressure electrolysis cell 30. FIGS. 5A to 5C are cross-sectional explanatory views showing an example of the method of producing the differential pressure electrolysis cell 30. As shown in FIG. 4, in step S1, the electrolyte membrane 46 is formed.

To be specific, as shown in FIG. 5A, for example, a first ionomer material having a first ion exchange capacity per unit area is applied onto a film formation substrate 200 to form the first layer 82. Subsequently, as shown in FIG. 5B, a third ionomer material having a third ion exchange capacity per unit area is applied onto the first layer 82 to form the intermediate layer 86. Then, as shown in FIG. 5C, a second ionomer material having a second ion exchange capacity per unit area is applied onto the intermediate layer 86 to form the second layer 84. Thus, the electrolyte membrane 46 in which the first layer 82, the intermediate layer 86, and the second layer 84 are laminated is formed. Thereafter, the process transitions to step S2.

In step S2, the electrolyte membrane is placed. In step S2, the electrolyte membrane 46 is placed between the first electrode 48 and the second electrode 50 such that the first layer 82 faces the first electrode 48 and the second layer 84 faces the second electrode 50. Thus, the membrane electrode assembly 38 is produced. Thereafter, the process transitions to step S3.

In step S3, the electrolysis cell is assembled. In step S3, components of the differential pressure electrolysis cell 30, such as the membrane electrode assembly 38, the pair of separators 40, the frame member 42, the support member 64, the load applying mechanism 68, the annular member 78, and so on, are assembled. Thus, the differential pressure electrolysis cell 30 is produced. A plurality of such differential pressure electrolysis cells 30 are produced, and the plurality of differential pressure electrolysis cells 30 are stacked one another and sandwiched between the pair of end plates 22, whereby the differential pressure electrolysis stack 10 is produced.

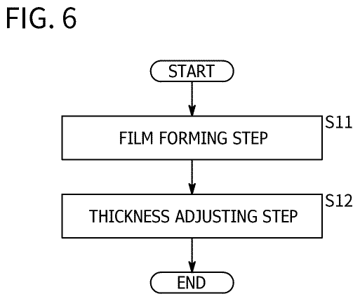

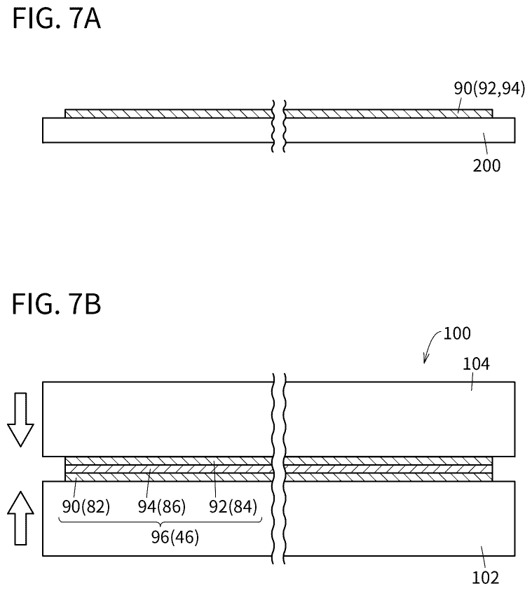

The method for producing the differential pressure electrolysis cell 30 is not limited to the above-described example. FIG. 6 is a flowchart showing an example of a step of forming the electrolyte membrane. FIG. 7A and FIG. 7B are cross-sectional views illustrating an example of the step of forming the electrolyte membrane. As shown in FIG. 6, in step S11, a film forming is performed.

To be specific, as shown in FIG. 7A, in step S11, for example, a first ionomer material having a first ion exchange capacity per unit area is applied onto the film formation substrate 200 to form a first film 90. A second ionomer material having a second ion exchange capacity per unit area is applied onto the film formation substrate 200 to form a second film 92. Further, a third ionomer material having a third ion exchange capacity per unit area is applied onto the film formation substrate 200 to form a third film 94. Thereafter, the first film 90, the third film 94, and the second film 92 are laminated in this order to form a film laminate 96 (see FIG. 7B). Thereafter, the process transitions to step S12.

In step S12, a thickness-adjusting step is performed. In particular, as shown in FIG. 7B, the film laminate 96 is pressed in the thickness-wise direction to adjust the film laminate 96 to a predetermined width. In the present embodiment, the film laminate 96 is hot-pressed by a hot press apparatus 100. The hot press apparatus 100 includes a first die 102 and a second die 104, and the film laminate 96 is hot-pressed between the first die 102 and the second die 104. Thus, the first film 90, the third film 94, and the second film 92 are joined to each other to form the electrolyte membrane 46.

Next, basic operations of the differential pressure electrolysis stack 10 according to the present embodiment will be briefly described. In the present embodiment, in the case of electrolyzing a fluid, the fluid is supplied to the inlet 24 of the differential pressure electrolysis stack 10, and a voltage is applied between the first electrode 48 and the second electrode 50 by the electrolytic power supply 18. The fluid supplied to the inlet 24 is guided to the first electrode 48 of each differential pressure electrolysis cell 30 via the fluid supply passage 32. In each differential pressure electrolysis cell 30, a gas is produced at the second electrode 50 by the electrolysis of the fluid. The gas produced at the second electrode 50 is guided out to the gas discharge path 13 via the produced gas discharge passage 36. The gas produced at the second electrode 50 is increased in its pressure by being sealed by the back pressure valve 14. Accordingly, a high pressure gas may be produced at the second electrode 50. In each of the differential pressure electrolysis cells 30, the discharge fluid containing unreacted fluid that has not been electrolyzed flows to the outlet 26 via the fluid discharge passage 34 and is discharged to the outside.

In the present embodiment, the differential pressure electrolysis cell 30 may be a differential pressure water electrolysis cell or an electrochemical hydrogen compressor cell. Hereinafter, an example in which the differential pressure electrolysis cell 30 is a differential pressure water electrolysis cell and an example in which the differential pressure electrolysis cell 30 is an electrochemical hydrogen compressor cell will be described.

In the case where the differential pressure electrolysis cell 30 is a differential pressure water electrolysis cell, for example, the electrolyte membrane 46 may be a proton exchange membrane, the first electrode 48 may serve as an anode, and the second electrode 50 may serve as a cathode. In this case, water supplied to the first electrode 48 is electrolyzed at the first electrode 48, and hydrogen ions and oxygen gas are generated. The generated hydrogen ions accompanied by water move through the electrolyte membrane 46 from the first electrode 48 to the second electrode 50. In this manner, the electrolyte membrane 46 is humidified while the hydrogen ions are being supplied to the second electrode 50. At the second electrode 50, hydrogen ions are combined to produce hydrogen gas. When the pressure of the hydrogen gas produced at the second electrode 50 becomes equal to or higher than a threshold, the hydrogen gas flows to and is stored in the tank 16 via the back pressure valve 14. Water supplied to the first electrode 48 but not reacted and oxygen gas generated at the first electrode 48 are discharged to the outside as a discharge fluid via the fluid discharge passage 34.

In addition, in a case where the differential pressure electrolysis cell 30 is a differential pressure water electrolysis cell, for example, the electrolyte membrane 46 may be an anion exchange membrane, the first electrode 48 may serve as an anode, and the second electrode 50 may serve as a cathode. In this case, the water supplied to the first electrode 48 moves through the electrolyte membrane 46 from the first electrode 48 to the second electrode 50. The water humidifies the electrolyte membrane 46 while being supplied to the second electrode 50. At the second electrode 50, the water is electrolyzed, and thus hydrogen gas is produced and hydroxide ions are generated. When the pressure of the hydrogen gas produced at the second electrode 50 becomes equal to or higher than a threshold, the hydrogen gas flows to and is stored in the tank 16 via the back pressure valve 14. The hydroxide ions generated at the second electrode 50 move through the electrolyte membrane 46 from the second electrode 50 to the first electrode 48. At the first electrode 48, oxygen gas and water are generated from the hydroxide ions. The water present at the first electrode 48 and the oxygen gas generated at the first electrode 48 are discharged as a discharge fluid to the outside through the fluid discharge passage 34.

Further, in the case where the differential pressure electrolysis cell 30 is a differential pressure water electrolysis cell, for example, the electrolyte membrane 46 may be a proton exchange membrane, the first electrode 48 may serve as a cathode, and the second electrode 50 may serve as an anode. In this case, water supplied to the first electrode 48 moves through the electrolyte membrane 46 from the first electrode 48 to the second electrode 50. The water humidifies the electrolyte membrane 46 while being supplied to the second electrode 50. At the second electrode 50, the water is electrolyzed to generate hydrogen ions and produce oxygen gas. When the pressure of the oxygen gas produced at the second electrode 50 becomes equal to or higher than a threshold, the oxygen gas flows to and is stored in the tank 16 via the back pressure valve 14. The hydrogen ions generated at the second electrode 50 move through the electrolyte membrane 46 from the second electrode 50 to the first electrode 48. At the first electrode 48, hydrogen ions are combined to generate hydrogen gas. The hydrogen gas and the water that has been supplied to the first electrode 48 but not reacted are discharged to the outside as a discharge fluid via the fluid discharge passage 34.

In addition, in a case where the differential pressure electrolysis cell 30 is a differential pressure water electrolysis cell, for example, the electrolyte membrane 46 may be an anion exchange membrane, the first electrode 48 may serve as a cathode, and the second electrode 50 may serve as an anode. In this case, water supplied to the first electrode 48 is electrolyzed at the first electrode 48, and hydrogen gas and hydroxide ions are generated. The generated hydroxide ions accompanied by water move through the electrolyte membrane 46 from the first electrode 48 to the second electrode 50. In this manner, the electrolyte membrane 46 is humidified while the hydroxide ions are supplied to the second electrode 50. At the second electrode 50, oxygen gas and water are generated from the hydroxide ions. When the pressure of the oxygen gas produced at the second electrode 50 becomes equal to or higher than a threshold, the oxygen gas flows to and is stored in the tank 16 via the back pressure valve 14. Water supplied to the first electrode 48 but not reacted and hydrogen gas generated at the first electrode 48 are discharged to the outside as a discharge fluid via the fluid discharge passage 34.

In the case where the differential pressure electrolysis cell 30 is an electrochemical hydrogen compressor cell, for example, the electrolyte membrane 46 may be a proton exchange membrane, the first electrode 48 may serve as an anode, and the second electrode 50 may serve as a cathode. In this case, hydrogen gas containing water is supplied to the first electrode 48. The hydrogen gas is electrolyzed in the first electrode 48, and hydrogen ions are generated. The generated hydrogen ions accompanied by water move through the electrolyte membrane 46 from the first electrode 48 to the second electrode 50. In this manner, the electrolyte membrane 46 is humidified while the hydrogen ions are being supplied to the second electrode 50. At the second electrode 50, hydrogen ions are combined to produce hydrogen gas. When the pressure of the hydrogen gas produced at the second electrode 50 becomes equal to or higher than a threshold, the hydrogen gas flows to and is stored in the tank 16 via the back pressure valve 14. The hydrogen gas guided to the first electrode 48 but has not reacted is discharged as a discharge fluid to the outside through the fluid discharge passage 34.

In the differential pressure electrolysis cell 30, the water moving through the electrolyte membrane 46 from the first electrode 48 to the second electrode 50 is pushed back to the first electrode 48 by the high pressure gas produced at the second electrode 50. Therefore, the portion of the electrolyte membrane 46 facing the second electrode 50 is more likely to be dried out than the portion facing the first electrode 48.

In the present embodiment, the second ion exchange capacity of the second layer 84 facing the second electrode 50 is larger than the first ion exchange capacity of the first layer 82 facing the first electrode 48. In other words, the second layer 84 having a larger ion exchange capacity per unit area than the first ion exchange capacity of the first layer 82 facing the first electrode 48 is disposed so as to face the second electrode 50 where a high pressure gas is produced. The first layer 82 having a smaller ion exchange capacity per unit area than the second ion exchange capacity of the second layer 84 facing the second electrode 50 is disposed so as to face the first electrode 48 to which the fluid containing water is supplied. In this case, the maximum water content of the second layer 84 can be made larger than the maximum water content of the first layer 82. Therefore, even in the case where the water moving through the electrolyte membrane 46 from the first electrode 48 to the second electrode 50 is pushed back by the high pressure gas produced in the second electrode 50, the second layer 84 can be prevented from being excessively dried out. In other words, it is possible to suppress the water content of the electrolyte membrane 46 from varying in the thickness direction of the electrolyte membrane 46. This also suppresses a decrease in the efficiency of electrolysis due to drying of the electrolyte membrane 46. That is, by suppressing drying of the portion of the electrolyte membrane 46 facing the second electrode 50, a decrease in the efficiency of electrolysis can be suppressed. In addition, it is possible to suppress the progress of deterioration of the electrolyte membrane 46 due to an increase in electrical resistance caused by drying of the electrolyte membrane 46. That is, the progress of deterioration of the electrolyte membrane 46 can be suppressed by keeping the portion of the electrolyte membrane 46 facing the second electrode 50 from being dried out. Therefore, it is possible to provide a more favorable differential pressure electrolysis cell 30, differential pressure electrolysis stack 10, and method for producing a differential pressure electrolysis cell 30.

The following supplementary notes are further disclosed in relation to the above embodiment.

### Supplementary Note 1

The differential pressure electrolysis cell (30) according to the present disclosure including the membrane electrode assembly (38) including the electrolyte membrane (46) sandwiched between the first electrode (48) and the second electrode (50), wherein the differential pressure electrolysis cell is configured to cause a gas to be produced at the second electrode by applying a voltage between the first electrode and the second electrode for electrolyzing a fluid that contains water and is supplied to the first electrode, a pressure of the gas is higher than a pressure of the fluid, the electrolyte membrane includes: the first layer (82) facing the first electrode and having a first ion exchange capacity per unit area; and the second layer (84) facing the second electrode and having a second ion exchange capacity per unit area, and the second ion exchange capacity is larger than the first ion exchange capacity.

With the arrangement, the second ion exchange capacity of the second layer facing the second electrode is larger than the first ion exchange capacity of the first layer facing the first electrode. In this case, the maximum water content of the second layer can be made larger than the maximum water content of the first layer. Therefore, even in the case where the water moving through the electrolyte membrane from the first electrode to the second electrode is pushed back by the high pressure gas produced in the second electrode, the second layer can be prevented from being excessively dried out. In other words, it is possible to suppress the electrolyte membrane from varying in water content in its thickness direction. This also suppresses a decrease in the efficiency of electrolysis due to drying of the electrolyte membrane. That is, by suppressing drying of the portion of the electrolyte membrane facing the second electrode, a decrease in the efficiency of electrolysis can be suppressed. In addition, it is possible to suppress the progress of deterioration of the electrolyte membrane due to an increase in electrical resistance caused by drying of the electrolyte membrane. That is, the progress of deterioration of the electrolyte membrane can be suppressed by keeping the portion of the electrolyte membrane facing the second electrode from being dried out. In this manner, a better differential pressure electrolysis cell can be provided.

### Supplementary Note 2

In the differential pressure electrolysis cell according to Supplementary Note 1, the electrolyte membrane may include the intermediate layer (86) disposed between the first layer and the second layer and having a third ion exchange capacity per unit area, and the third ion exchange capacity may be larger than the first ion exchange capacity and smaller than the second ion exchange capacity.

According to such a configuration, the maximum water content of the intermediate layer can be made larger than the maximum water content of the first layer and smaller than the maximum water content of the second layer. This makes it possible to keep the electrolyte membrane from varying in water content in the thickness direction of the electrolyte membrane.

### Supplementary Note 3

In the differential pressure electrolysis cell according to Supplementary Note 1 or 2, a thickness of the first layer and a thickness of the second layer may be different from each other.

According to such a configuration, the water content of the first layer and the water content of the second layer can be adjusted by making the thickness of the first layer and the thickness of the second layer different from each other.

### Supplementary Note 4

In the differential pressure electrolysis cell according to Supplementary Note 1, the first layer may be made of a first ionomer material having the first ion exchange capacity, and the second layer may be made of a second ionomer material having the second ion exchange capacity.

According to such a configuration, the ion exchange capacity of the first layer and the ion exchange capacity of the second layer can be easily adjusted.

### Supplementary Note 5

The differential pressure electrolysis stack (10) according to the present disclosure includes the cell stack body (20) in which a plurality of the differential pressure electrolysis cells according to any one of Supplementary Notes 1 to 4 are stacked.

According to such a configuration, it is possible to obtain a differential pressure electrolysis stack that exhibits the effects described in Supplementary Notes 1 to 4. Thus, a better differential pressure electrolysis stack can be provided.

### Supplementary Note 6

The method of producing a differential pressure electrolysis cell according to the present disclosure, the differential pressure electrolysis cell including a membrane electrode assembly including an electrolyte membrane sandwiched between a first electrode and a second electrode, the differential pressure electrolysis cell being configured to cause a gas to be produced at the second electrode by applying a voltage between the first electrode and the second electrode for electrolyzing a fluid that contains water and is supplied to the first electrode, a pressure of the gas being higher than a pressure of the fluid, the method including: an electrolyte membrane forming step of forming an electrolyte membrane including a first layer having a first ion exchange capacity per unit area and a second layer having a second ion exchange capacity per unit area; and a placing step of placing the electrolyte membrane between the first electrode and the second electrode in such a manner that the first layer faces the first electrode and the second layer faces the second electrode.

According to such a method, the differential pressure electrolysis cell described in Supplementary Note 1 can be produced. Therefore, a more favorable method of producing a differential pressure electrolysis cell can be provided.

### Supplementary Note 7

In the method of producing a differential pressure electrolysis cell according to Supplementary Note 6, the electrolyte membrane forming step may include: a film forming step of forming the film laminate (96) by laminating the first film (90) formed of a first ionomer material having the first ion exchange capacity and the second film (92) formed of a second ionomer material having the second ion exchange capacity; and a thickness adjusting step of adjusting the film laminate to a predetermined thickness by pressing the film laminate in a thickness direction.

According to such a method, a good electrolyte membrane including the first layer and the second layer can be easily produced.

The present disclosure is not limited to the configuration described above. The intermediate layer disposed between the first layer and the second layer may be formed of a plurality of layers. In this case, the ion exchange capacity of each of the plurality of layers forming the intermediate layer is larger than the first ion exchange capacity and smaller than the second ion exchange capacity.

Although concerning the present disclosure, a detailed description thereof has been presented above, the present disclosure is not necessarily limited to the individual embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the operations and the order of each of the processes are shown merely as examples, and the present invention is not necessarily limited to these examples. The same applies also in the case that numerical values or mathematical expressions are used in the description of the aforementioned embodiments.

1. A differential pressure electrolysis cell comprising a membrane electrode assembly including an electrolyte membrane sandwiched between a first electrode and a second electrode, the differential pressure electrolysis cell being configured to cause a gas to be produced at the second electrode by applying a voltage between the first electrode and the second electrode for electrolyzing a fluid that contains water and is supplied to the first electrode, a pressure of the gas being higher than a pressure of the fluid, wherein
the electrolyte membrane includes:
a first layer facing the first electrode and having a first ion exchange capacity per unit area; and
a second layer facing the second electrode and having a second ion exchange capacity per unit area, and
the second ion exchange capacity is larger than the first ion exchange capacity.

2. The differential pressure electrolysis cell according to claim 1, wherein
the electrolyte membrane includes an intermediate layer placed between the first layer and the second layer and having a third ion exchange capacity per unit area, and
the third ion exchange capacity is larger than the first ion exchange capacity and smaller than the second ion exchange capacity.

3. The differential pressure electrolysis cell according to claim 1, wherein
a thickness of the first layer and a thickness of the second layer are different from each other.

4. The differential pressure electrolysis cell according to claim 1, wherein
the first layer is made of a first ionomer material having the first ion exchange capacity per unit area, and
the second layer is made of a second ionomer material having the second ion exchange capacity per unit area.

5. A differential pressure electrolysis stack comprising a cell stack body in which a plurality of the differential pressure electrolysis cells according to claim 1 are stacked.

6. A method of producing a differential pressure electrolysis cell comprising a membrane electrode assembly including an electrolyte membrane sandwiched between a first electrode and a second electrode, the differential pressure electrolysis cell being configured to cause a gas to be produced at the second electrode by applying a voltage between the first electrode and the second electrode for electrolyzing a fluid that contains water and is supplied to the first electrode, a pressure of the gas being higher than a pressure of the fluid,
the method including:
forming an electrolyte membrane including a first layer having a first ion exchange capacity per unit area and a second layer having a second ion exchange capacity per unit area; and
placing the electrolyte membrane between the first electrode and the second electrode in a manner so that the first layer faces the first electrode and the second layer faces the second electrode.

7. The method of producing the electrolysis cell according to claim 6, wherein
the forming of the electrolyte membrane includes:
forming a film laminate by laminating a first film formed of a first ionomer material having the first ion exchange capacity and a second film formed of a second ionomer material having the second ion exchange capacity; and
adjusting the film laminate to a predetermined thickness by pressing the film laminate in a thickness direction.
